(19) United States
(12) Patent Application Publication
(10) Pub. No.: US 2012/0268914 A1
(43) Pub. Date: Oct. 25, 2012

(54) INPUT DEVICE

(75) Inventor: Yoshifumi MASUMOTO, Niigata-ken (JP)

(73) Assignee: ALPS ELECTRIC CO., LTD., Tokyo (JP)

(21) Appl. No.: 13/365,190

(22) Filed: Feb. 2, 2012

(30) Foreign Application Priority Data
Apr. 22, 2011 (JP) 2011-095686

(51) Int. Cl. F21V 9/14

(52) U.S. Cl. 362/19

(57) ABSTRACT

An input device, disposed in front of a display device, includes a polarizing film, a λ/4 retardation film, and a touch sensor unit including first and second light transmissive films arranged farther from the outside of the input device than the polarizing film. Each of the first and second light transmissive films is formed of a film controlled such that it is approximately optically isotropic. The film exhibits birefringence caused by drawing in the machine direction upon manufacture such that the slow axis extends along the machine direction. The machine direction of the film is allowed to be orthogonal to that of the other film, thus allowing the slow axes to be orthogonal to each other in order to cancel out the slow axes such that the input device is generally isotropic.

### CLAIM OF PRIORITY

This application claims benefit of Japanese Patent Application No. 2011-095686 filed on Apr. 22, 2011, which is hereby incorporated by reference.

### BACKGROUND OF THE INVENTION

1. Field of the Invention

The present invention relates to light transmissive input devices each disposed in front of a display device, and in particular, relates to an input device having a function of preventing reflection of external light.

2. Description of the Related Art

Various electronic apparatuses, such as a portable apparatus, each include a light transmissive input device disposed in front of a display device. For example, the input device is of the capacitive sensing type and includes light transmissive electrode layers intersecting each other. When a human finger approaches the input device, a detected output varies depending on a capacitance formed between the electrode layer and the finger.

In an electronic apparatus including a light transmissive input device, external light passing through the input device may be reflected by a display screen of a display device positioned behind the input device or an electrode layer included in the display device. Unfortunately, information, such as an image or text, displayed by the display device may be difficult to see.

Japanese Unexamined Patent Application Publication No. 2008-262326 discloses a touch panel which includes a polarizing plate including a polarizing layer and a ¼-wavelength retardation layer, an upper substrate having thereon a light transmissive electrode layer, and a lower substrate having thereon a light transmissive electrode layer such that the polarizing plate serves as an uppermost layer and the upper and lower substrates are arranged under the polarizing plate. The touch panel further includes a polarizing plate disposed between the lower substrate and a liquid crystal display device.

Domestic Re-publication of PCT International Publication for Patent Application No. WO2006/028131 discloses a touch panel which includes a λ/4 retardation plate and two transparent substrates each having thereon a transparent conductive film such that the plate and the substrates are arranged in front of a display device. The touch panel further includes a polarizing plate disposed in front of the substrate.

In each of the related art disclosed in Japanese Unexamined Patent Application Publication No. 2008-262326 and that disclosed in Domestic Re-publication of PCT International Publication for Patent Application No. 2006/028131, the λ/4 retardation plate and the polarizing plate are arranged in front of the display device to prevent internal reflection of external light.

In each of the above-described related arts, external light is linearly polarized by the polarizing plate and the linearly polarized light is converted to circularly polarized light due to birefringence of the λ/4 retardation plate. When the circularly polarized light is reflected by a reflection surface, the phase of the light is shifted by 180 degrees such that the circularly polarized light rotates in the opposite direction. The circularly polarized light again passes through the λ/4 retardation plate, so that the light is linearly polarized. The polarizing plate prevents output of the linearly polarized light.

In this case, if birefringence is exhibited by the two transparent substrates each having the transparent electrode layer arranged behind the polarizing plate, phase shifts due to the birefringence of the transparent substrates will be added to a phase shift by the λ/4 retardation plate, so that light passing through the λ/4 retardation plate may tend to be converted not to circularly polarized light but to elliptically polarized light. Disadvantageously, a problem will tend to occur, for example, the effect of preventing reflection may be reduced, alternatively, a displayed image may be colored, for example, brown.

In the related art disclosed in Domestic Re-publication of PCT International Publication for Patent Application No. 2006/028131, each transparent substrate having the transparent conductive layer is an isotropic substrate. To form an isotropic film into a substrate, drawing force is applied to the film in the machine direction (MD) of the film during manufacture. Accordingly, the film is not completely optically isotropic, so that it may exhibit birefringence. The degree of anisotropy is not so high. In the use of two isotropic films, each having an electrode layer, laid one upon another such that the machine direction of one film extends in the same direction as the machine direction of the other film, however, the anisotropy is increased. Disadvantageously, the above-described optical problems may tend to occur.

### SUMMARY OF THE INVENTION

The present invention solves the above-described problems and provides an input device configured such that degradation of an antireflection function or coloring transmitted light is easily prevented even when an included light transmissive film having thereon an electrode layer exhibits birefringence.

The present invention provides an input device disposed in front of a display device, the input device including a polarizing layer, a λ/4 retardation layer disposed farther from the outside of the input device than the polarizing layer, and a detecting film disposed farther from the outside than the polarizing layer, wherein two light transmissive films are arranged farther from the outside than the polarizing layer, the films being laid one upon another such that the machine direction of the film intersects that of the other film, and at least one of the light transmissive films is the detecting film having a light transmissive electrode layer on its surface.

The input device according to the present invention includes the polarizing layer and the λ/4 retardation layer to provide an antireflection function. Preferably, the detecting film included in the input device is formed of an optically isotropic light transmissive film. For example, if a resin film in which optical anisotropy partially occurs at random, i.e., a material whose birefringence is not controlled is used, a rate at which reflected light is prevented varies from part to part, alternatively, reflected light tends to be colored rainbow, for example. Even if a resin film said to be optically isotropic is used, its optical isotropy is not complete because drawing force has acted in the machine direction upon manufacture. Such a material inevitably exhibits birefringence such that its slow axis extends along the machine direction. Thus, a phase shift provided by the detecting film is added to a phase shift provided by the λ/4 retardation layer, so that the effect of preventing reflection of external light is reduced or reflected light tends to be colored, for example, brown.

According to the present invention, therefore, the two light transmissive films are used. At least one of the films functions as the detecting film. The machine directions of the films are allowed to intersect each other, so that the slow axis of birefringence of the film is allowed to intersect that of the other film. Thus, phase shifts caused in the light transmissive films are cancelled out. Accordingly, the function of preventing reflected light is increased and reflected light is easily prevented from being colored.

As regards the light transmissive films in the present invention, a film in which the slow axis of birefringence lies in the range of −15 degrees to +15 degrees relative to the machine direction is used. Preferably, each light transmissive film provides a birefringence-induced phase shift ranging from 3 to 20 nm

Only one of the two light transmissive films may be the detecting film having the electrode layer. Alternatively, each of the two light transmissive films may be the detecting film having the electrode layer.

The two light transmissive films may have the same relationship between the machine direction and a direction in which the electrode layer extends, and the two light transmissive films may be laid one upon another such that the electrode layer on the film intersects that on the other film, thus allowing the machine direction of the film to intersect that of the other film.

As described above, so long as the machine direction is related to the direction in which the electrode layer extends, assembly is performed such that the electrode layers of the two light transmissive films are allowed to intersect each other, so that the machine directions of the films are inevitably allowed to intersect each other.

The polarizing layer, the λ/4 retardation layer, and the two light transmissive films may be arranged in front of a liquid crystal display device. Alternatively, the polarizing layer, the λ/4 retardation layer, and the two light transmissive films may be arranged in front of an electroluminescent display device.

### BRIEF DESCRIPTION OF THE DRAWINGS

FIG. 1 is an exploded perspective view of a portable apparatus including an input device according to an embodiment of the present invention;

FIG. 2 is a cross-sectional view of an input device and a display device according to a first embodiment of the present invention;

FIG. 3 is a cross-sectional view of the input device and a display device according to a second embodiment of the present invention;

FIG. 4 is a diagram explaining optical characteristics of layers constituting the input device;

FIG. 5 is a diagram explaining another combination of optical characteristics of layers constituting an input device; and

FIG. 6 is an exploded perspective view of exemplary arrangement of detecting films.

### DESCRIPTION OF THE PREFERRED EMBODIMENTS

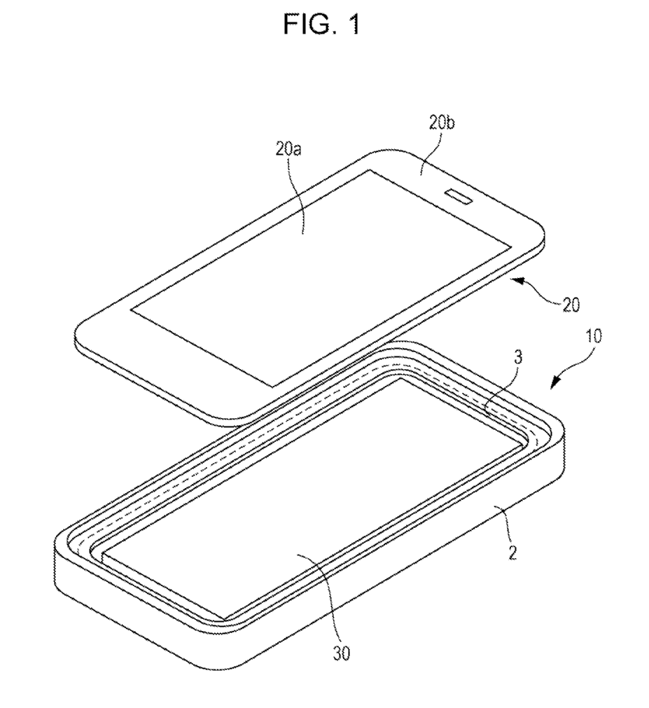

FIG. 1 illustrates a portable apparatus 10, such as a cellular phone, a portable information processor, a portable memory, or a portable game machine.

The portable apparatus 10 includes a plastic casing 2. The casing 2 has an upwardly opened recess 3, which receives a circuit board including an electronic circuit and a display device 30. An opening of the recess 3 is closed by an input device 20 according to an embodiment of the present invention. The input device 20 includes a display area 20a through which display light emitted from the display device 30 passes and a non-display area 20b which surrounds the display area 20a and is colored such that light does not pass through this area.

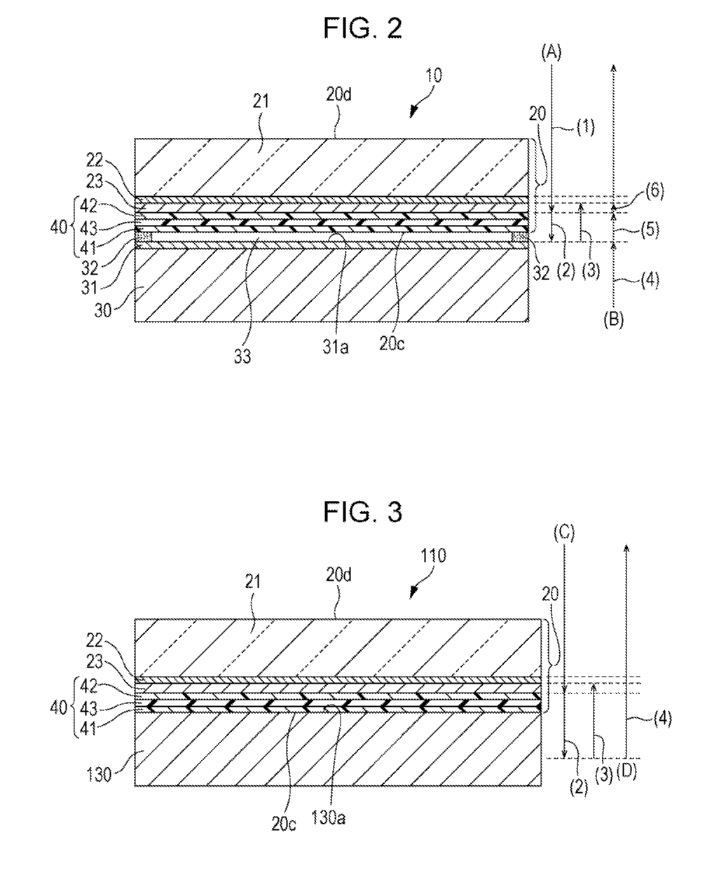

Referring to FIG. 2, the display device 30, included in the portable apparatus 10, includes a liquid crystal display device and a backlight unit, which provides light emitted from an LED or a lamp to the rear of the liquid crystal display device.

The liquid crystal display device includes a liquid crystal layer, transparent electrodes opposed to each other with the liquid crystal layer disposed therebetween, alignment layers opposed to each other with the liquid crystal layer therebetween, and polarizing layers opposed to each other with the liquid crystal layer therebetween. Accordingly, display light coming from the backlight unit and passing through the liquid crystal display device is linearly polarized light. The front surface of the display device 30 from which display light emerges is provided with a λ/4 retardation film 31.

A spacer 32 is fixed to the front surface, indicated at 31a, of the λ/4 retardation film 31. The input device 20 is fixed to the front surface of the spacer 32. The input device 20 has a rear surface 20c that faces the display device 30 and a front surface 20d from which display light emerges. The spacer 32 is frame-shaped so as to surround the display area 20a of the input device 20. In the display area 20a, a thin space 33 is provided between the front surface 31a of the λ/4 retardation film 31 and the rear surface 20c of the input device 20. The spacer 32 is a double-faced tape, an adhesive layer, or a pressure sensitive adhesive layer.

Referring to FIG. 2, the input device 20 includes a light transmissive covering layer 21. A surface of the covering layer 21 serves as the front surface 20d. In this specification, the term “light transmissive” means a transparent or translucent state in which light is transmissive and means that the total light transmittance is 50% or higher, preferably, 80% or higher.

The covering layer 21 comprises glass or light transmissive resin, such as polymethyl methacrylate (PMMA), polycarbonate (PC), cyclic olefin copolymer (COP), or triacetyl cellulose (TAC). A decorating layer is provided on the rear or front surface of the covering layer 21. The decorating layer is colored such that light does not pass through the non-display area 20b as illustrated in FIG. 1.

A polarizing film 22, serving as a polarizing layer, and a λ/4 retardation film 23, serving as a λ/4 retardation layer, and a touch sensor unit 40 are arranged in that order under (or on the rear of) the covering layer 21 such that the films 22 and 23 and the unit 40 are farther from the outside of the input device 20 than the covering layer 21. The covering layer 21 and the other layers arranged farther from the outside of the input device 20 than the layer 21 are bonded to one another with light transmissive adhesive, such as acrylic adhesive.

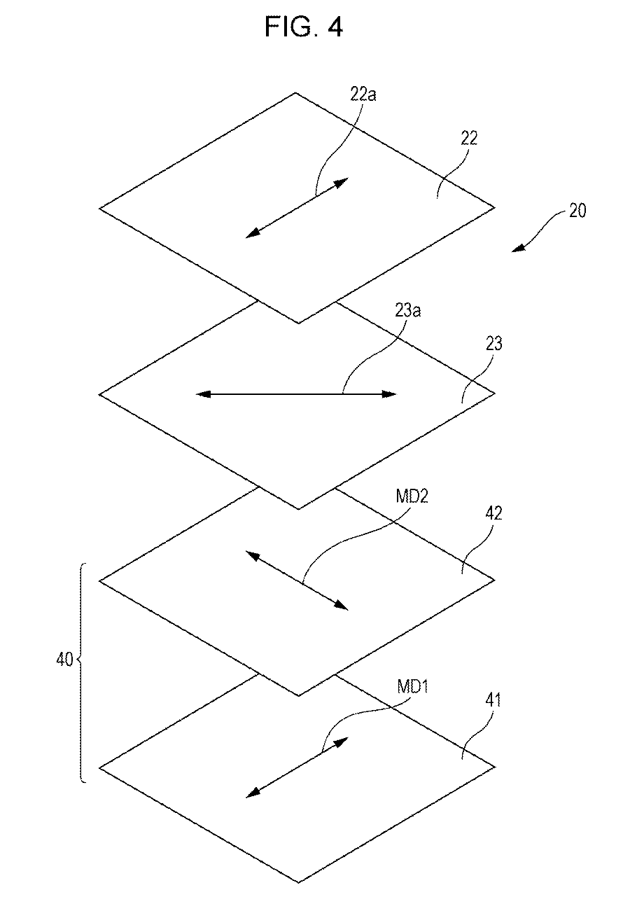

FIG. 4 illustrates the direction of the absorption axis, indicated at 22a, of the polarizing film 22 and that of the slow axis, indicated at 23a, of the λ/4 retardation film 23. The direction of the absorption axis 22a of the polarizing film 22 disposed farther from the outside than the covering layer 21 may be the same as that of the absorption axis of a polarizing layer disposed on the side from which display light of the display device 30, serving as the liquid crystal display device, emerges. The direction of the slow axis 23a of the λ/4 retardation film 23 positioned farther from the outside than the covering layer 21 may be orthogonal to that of the slow axis of the λ/4 retardation film 31 disposed on the front surface of the display device 30.

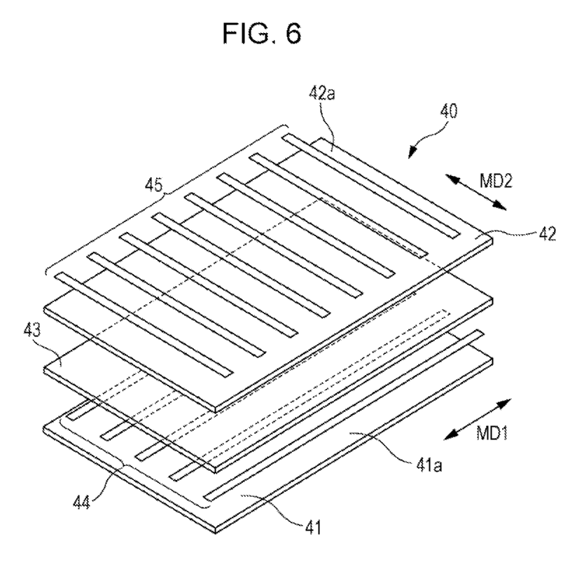

Referring to FIG. 6, the touch sensor unit 40 includes a first light transmissive film 41, a second light transmissive film 42, and an insulating layer 43 disposed therebetween. The films 41 and 42 and the insulating layer 43 are bonded to one another with light transmissive adhesive, such as acrylic adhesive. Alternatively, the insulating layer 43 may be a light transmissive adhesive layer. Segments of a first electrode layer 44 are arranged on the front surface, indicated at 41a, of the first light transmissive film 41. Segments of a second electrode layer 45 are arranged on the front surface, indicated at 42a, of the second light transmissive film 42. The first and second electrode layers 44 and 45 each comprise indium tin oxide (ITO) or a light transmissive organic conductive layer.

Each of the first and second light transmissive films 41 and 42 may comprise resin, such as COP or TAC, having optical properties which are easy to control. The birefringence of a light transmissive film comprising COP or TAC is easy to control. Accordingly, such a film can be formed such that it is approximately optically isotropic. During manufacture of the film, while the film is being transferred between rolls, drawing force acts in the machine direction of the film, so that molecules of the film are aligned in the machine direction. The film therefore exhibits birefringence. The slow axis of birefringence extends substantially along the machine direction.

Specifically, even a light transmissive film, called an isotropic film, exhibits such a birefringence that the slow axis lies in the range of −15 degrees to +15 degrees relative to the machine direction. Inevitably, a birefringence-induced phase shift is in the range of 3 to 20 nm. Typically, even if the slow axis of birefringence lies in the range of −10 degrees to +10 degrees relative to the machine direction and the birefringence-induced phase shift is in the range of 3 to 10 nm, such a film will be called an optically isotropic film.

Referring to FIG. 4, the machine direction, indicated at MD1, of the first light transmissive film 41 is orthogonal to the machine direction, indicated at MD2, of the second light transmissive film 42, the films 41 and 42 constituting the touch sensor unit 40.

Preferably, the first and second light transmissive films 41 and 42 are films made by the same manufacturing process. More preferably, the first and second light transmissive films 41 and 42 are cut from a continuous film web. Accordingly, the first and second light transmissive films 41 and 42 may have the same relationship between the machine direction and the slow axis and have substantially the same birefringence-induced phase shift.

Allowing the machine direction MD 1 to be orthogonal to the machine direction MD2 permits the slow axis of the first light transmissive film 41 to be orthogonal to that of the second light transmissive film 42. The combination of the first and second light transmissive films 41 and 42 provides optical isotropy. Consequently, the phase shift of light passing through the λ/4 retardation film 23 can be prevented from being varied due to the birefringences of the light transmissive films 41 and 42.

Preferably, the first electrode layer segments 44 are arranged in parallel to the machine direction MD1 of the first light transmissive film 41 and the second electrode layer segments 45 are arranged in parallel to the machine direction MD2 of the second light transmissive film 42 as illustrated in FIG. 6. With this arrangement, upon combining the first and second light transmissive films 41 and 42, the first electrode layer segments 44 are allowed to be orthogonal to the second electrode layer segments 45. Thus, inevitably, the machine direction MD1 can be made orthogonal to the machine direction MD2.

Upon assembly of the touch sensor unit 40, therefore, the slow axes can be reliably made orthogonal to each other on the basis of the directions of the electrode layer segments without consideration of the machine directions. The same advantage can be obtained by the following arrangement. The machine direction MD1 of the first light transmissive film 41 is allowed to be orthogonal to the direction of the first electrode layer segments 44. The machine direction MD2 of the second light transmissive film 42 is allowed to be orthogonal to the direction of the second electrode layer segments 45. The first and second light transmissive films 41 and 42 are combined such that the electrode layer segments 44 and 45 are orthogonal to each other.

In the portable apparatus 10 of FIG. 1, display light output from the display device 30 passes through the display area 20a of the input device 20 and emerges on the front surface 20d of the input device 20. When a user touches the front surface 20d of the input device 20 with a finger while viewing an image displayed in the display area 20a, the touch sensor unit 40 detects a position touched by the finger.

In the touch sensor unit 40, a driving circuit (not illustrated) sequentially applies a voltage to the first electrode layer segments 44 and sequentially applies a voltage to the second electrode layer segments 45 at different timing. When a human finger, serving as a conductor having an approximately ground potential, touches the front surface 20d at a position close to any of the electrode layer segments, a capacitance is formed between the electrode layer segment and the finger, so that current flows to the finger upon application of the voltage. A position where the finger has approached the apparatus can be calculated on the basis of a detected change in current.

On the right of FIG. 2, (A) indicates a transmission path of external light (1) which enters the display area 20a of the input device 20 from the outside of the portable apparatus 10 and (B) indicates a transmission path of display light (4) emitted from the display device 30.

As indicated by (A) in FIG. 2, the external light (1) passing through the covering layer 21 passes through the polarizing film 22, so that the light is transformed into linearly polarized light. The linearly polarized light passes through the λ/4 retardation film 23, so that the light is transformed into circularly polarized light (2). The circularly polarized light (2) is then reflected on each interface between the adjacent layers. In particular, the circularly polarized light (2) is more easily reflected on the interface between the space 33 and the front surface 31a of the λ/4 retardation film 31 which serves as the front surface of the display device 30. The phase of each reflected circularly polarized light (2) is sequentially shifted. The reflected light having a phase shifted by 180 degrees is returned as circularly polarized light (3) rotating in the opposite direction. The circularly polarized light (3) again passes through the λ/4 retardation film 23, so that the light is transformed into linearly polarized light. The optical axis of the linearly polarized light is orthogonal to the absorption axis 22a of the polarizing film 22 positioned in the front of the input device 20. Accordingly, the reflected light is blocked by the polarizing film 22 such that the light is prevented from returning to the outside.

As indicated by (B) in FIG. 2, light emitted from the backlight unit passes through the liquid crystal display device in the display device 30. Since the polarizing layer is provided on the side of the liquid crystal display device which light emerges from, the passing light emerges as linearly polarized display light (4). The linearly polarized display light (4) passes through the λ/4 retardation film 31 positioned on the front of the display device 30, so that the light is transformed into circularly polarized light (5). The circularly polarized light (5) passes through the λ/4 retardation film 23 positioned in front of the display device 30, so that the light is transformed into linearly polarized light (6). The optical axis of the linearly polarized light (6) extends in the same direction as the absorption axis 22a of the polarizing film 22. Accordingly, the linearly polarized light (6) travels forward without being blocked by the polarizing film 22, so that the display light can be visually recognized.

In the input device 20, each of the first and second light transmissive films 41 and 42 constituting the touch sensor unit 40 comprises an optical film whose slow and fast axes are adjusted to exhibit a substantially isotropic property. Accordingly, the following problem does not occur: in the use of optically-unadjusted films whose optical properties vary from part to part at random, reflected light is rainbow-colored.

As described above, even a light transmissive film having optical properties close to isotropy exhibits birefringence due to the machine direction upon manufacture. Actually, a phase shift ranging from 3 to 20 nm occurs. Even in a film having optical properties closer to isotropy, a phase shift ranging from 3 to 10 nm occurs.

In this embodiment, the machine direction MD1 of the first light transmissive film 41 is allowed to be orthogonal to the machine direction MD2 of the second light transmissive film 42 such that the slow axis of birefringence of the film 41 is orthogonal to that of the film 42. Accordingly, the touch sensor unit 40 is generally optically isotropic. Consequently, the phase shift of light passing through the λ/4 retardation film 23 is not significantly deviated from λ/4. Reflected light can be processed as circularly polarized light. In other words, reflected light can be blocked by the polarizing film 22.

If the machine direction MD1 of the first light transmissive film 41 in which a phase shift ranging from 3 to 20 nm or from 3 to 10 nm occurs is aligned with the machine direction MD2 of the second light transmissive film 42, the touch sensor unit 40 generally exhibits large birefringence. In this case, the phase of light passing through the λ/4 retardation film 23 is shifted from λ/4, so that the light is transformed into elliptically polarized light. A rate at which reflected light is blocked is reduced. Disadvantageously, reflected light tends to be colored, for example, brown.

FIG. 3 illustrates a portable apparatus 110 according to a second embodiment of the present invention.

The input device 20 included in the portable apparatus 110 is the same as that in FIG. 2.

A display device 130 illustrated in FIG. 3 is a self-luminous display device, such as an organic electroluminescent display device. Display light emitted from the display device 130 is not linearly polarized light, circularly polarized light, or elliptically polarized light but artificial light similar to natural light. The rear surface 20c of the input device 20 is in tight contact with the front surface, indicated at 130a, of the display device 130.

On the right of FIG. 3, (C) indicates external light (1) which passes through the polarizing film 22 and the λ/4 retardation film 23, so that the light is transformed into circularly polarized light (2). Part of the circularly polarized light (2) enters the display device 130 and is then reflected by an electrode layer included in the display device 130. Since this reflected light is returned as circularly polarized light (3) rotating in the opposite direction, the circularly polarized light is transformed into linearly polarized light by the λ/4 retardation film 23 and is then blocked by the polarizing film 22.

As indicated by (D) in FIG. 3, since display light (4) emitted from the self-luminous display device 130 is artificial light similar to natural light, the display light passes through the λ/4 retardation film 23 and the polarizing film 22 and then emerges on the front surface 20d, so that displayed information, such as an image or text, is visible.

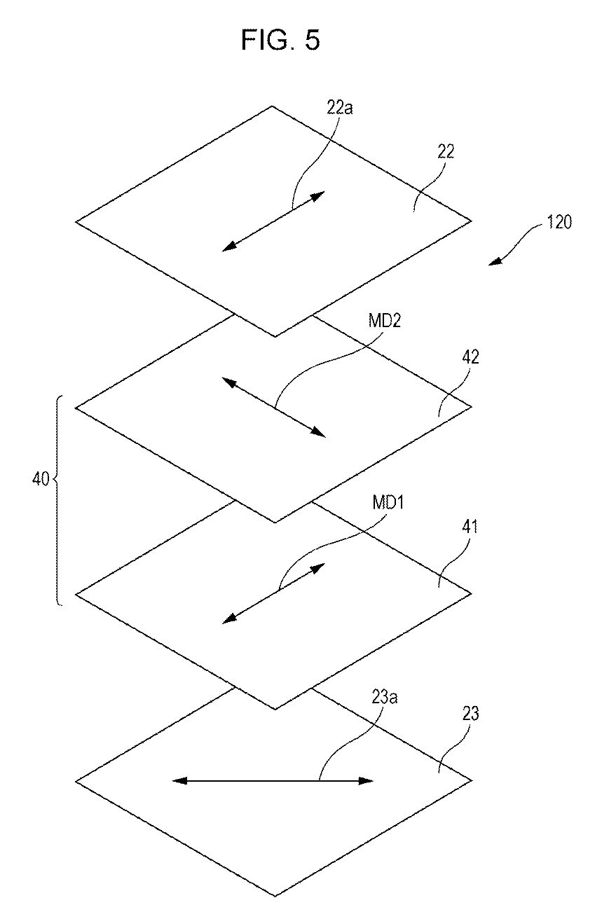

FIG. 5 illustrates another arrangement of layers constituting an input device.

The input device, indicated at 120, of FIG. 5 includes the polarizing film 22 positioned in the front thereof, and further includes the second light transmissive film 42 and the first light transmissive film 41, which constitute the touch sensor unit 40, such that the films 42 and 41 are farther from the outside of the input device 120 than the polarizing film 22. The input device 120 further includes the λ/4 retardation film 23 on the rear of the first light transmissive film 41.

In the input device 120, the machine direction MD1 of the first light transmissive film 41 is allowed to be orthogonal to the machine direction MD2 of the second light transmissive film 42 such that the touch sensor unit 40 is generally optically isotropic. Light passing through the λ/4 retardation film 23 can be easily prevented from being transformed into elliptically polarized light.

While the segments of the electrode layers 44 and 45 are arranged on the first and second light transmissive films 41 and 42, respectively, in the touch sensor unit 40 of FIG. 6, segments of two electrode layers may be arranged on both surfaces of a single light transmissive film, respectively, in the touch sensor unit. Alternatively, segments of a single electrode layer may be arranged on one surface of a single light transmissive film in the touch sensor unit. In this case, a light transmissive film (single detecting film) having thereon an electrode layer is overlaid with another light transmissive film having no electrode layer such that the machine direction of the light transmissive film (single detecting film) is orthogonal to that of the other light transmissive film. Thus, the same advantages as those of the foregoing embodiments are obtained.

As regards the display device, a liquid crystal display device which includes no polarizing plate on the side from which display light emerges may be used. The input device 20 or 120 may be disposed in front of the display device. The polarizing film 22 positioned in the front of the input device may be used as a polarizing plate on the light-emerging side of the liquid crystal display device.

What is claimed is:

1. An input device disposed in front of a display device, the input device comprising:
a polarizing layer;
a λ/4 retardation layer disposed farther from the outside of the input device than the polarizing layer; and
a detecting film disposed farther from the outside than the polarizing layer, wherein
two light transmissive films are arranged farther from the outside than the polarizing layer, the films being laid one upon another such that the machine direction of the film intersects that of the other film, and
at least one of the light transmissive films is the detecting film having a light transmissive electrode layer on its surface.

2. The device according to claim 1, wherein each of the two light transmissive films is the detecting film having the electrode layer.

3. The device according to claim 2, wherein
the two light transmissive films have the same relationship between the machine direction and a direction in which the electrode layer extends, and
the two light transmissive films are laid one upon another such that the electrode layer on the film intersects that on the other film, thus allowing the machine direction of the film to intersect that of the other film.

4. The device according to claim 1, wherein only one of the two light transmissive films is the detecting film having the electrode layer.

5. The device according to claim 4, wherein the electrode layer is disposed on each of both surfaces of the detecting film.

6. The device according to claim 4, wherein the electrode layer is disposed on only one surface of the detecting film.

7. The device according to claim 1, wherein the detecting film detects a change in current flowing to a human finger when a voltage is applied to the electrode layer while a capacitance is formed between the human finger and the electrode layer.

8. The device according to claim 1, wherein the polarizing layer and the λ/4 retardation layer are positioned in front of the two light transmissive films.

9. The device according to claim 1, wherein the polarizing layer is positioned in front of the two light transmissive films and the λ/4 retardation layer is positioned behind the light transmissive films.

10. The device according to claim 1, wherein the slow axis of birefringence of each light transmissive film lies in the range of −15 degrees to +15 degrees relative to the machine direction.

11. The device according to claim 1, wherein each light transmissive film provides a birefringence-induced phase shift ranging from 3 to 20 nm.

12. The device according to claim 10, wherein each light transmissive film provides a birefringence-induced phase shift ranging from 3 to 20 nm.

13. The device according to claim 10, wherein each light transmissive film comprises cyclic olefin copolymer or triacetyl cellulose.

14. The device according to claim 11, wherein each light transmissive film comprises cyclic olefin copolymer or triacetyl cellulose.

15. The device according to claim 12, wherein each light transmissive film comprises cyclic olefin copolymer or triacetyl cellulose.

16. The device according to claim 1, wherein the polarizing layer, the λ/4 retardation layer, and the two light transmissive films are arranged in front of a liquid crystal display device.

17. The device according to claim 16, wherein the absorption axis of the polarizing layer extends in the same direction as that of a polarizing layer disposed on a side of the liquid crystal display device from which display light emerges.

18. The device according to claim 16, wherein the slow axis of the λ/4 retardation layer is orthogonal to that of a λ/4 retardation layer disposed on the front surface of the liquid crystal display device.

19. The device according to claim 17, wherein the slow axis of the λ/4 retardation layer is orthogonal to that of a λ/4 retardation layer disposed on the front surface of the liquid crystal display device.

20. The device according to claim 1, wherein the polarizing layer, the λ/4 retardation layer, and the two light transmissive films are arranged in front of an electroluminescent display device.
